(19) United States
(12) Patent Application Publication
(10) Pub. No.: US 2002/0187240 A1
(43) Pub. Date: Dec. 12, 2002

(54) Flavored beverage compositions and method of making

(76) Inventors: Jerry Douglas Young, Cincinnati, OH (US); Douglas Craig Hardesty, Amelia, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/074,822

(22) Filed: Feb. 13, 2002

Related U.S. Application Data
(60) Provisional application No. 60/268,384, filed on Feb. 13, 2001.

(51) Int. Cl. C12C 1/00

(52) U.S. Cl. 426/590

(57) ABSTRACT

The present invention relates to novel beverage compositions with enhanced flavor characteristics. In particular, the present invention relates to novel processes for preparing beverage compositions and the products comprising them.

### CROSS REFERENCE TO RELATED APPLICATIONS

This application claims priority to U.S. Provisional Application No. 60/268,384, filed Feb. 13, 2001.

### FIELD OF THE INVENTION

The present invention relates to novel beverage compositions with enhanced flavor characteristics. In particular, the present invention relates to novel processes for preparing beverage compositions and the products comprising them.

### BACKGROUND OF THE INVENTION

High quality juice beverage products enjoy considerable popularity and make up an increasingly significant proportion of the diets of many people. However, these high quality juice products are both expensive to purchase and to produce. One such reason is the cost of the raw materials. Do to the nature of juice production (e.g., growing cycle, season, location, and the like) it is difficult to offset an increased demand for production costs for high quality beverage products that must eventually be borne by the consumer.

One such approach to reducing beverage production costs has been the use of low cost juices, and the subsequent adjustment of overall acidity to match that of the consumer preferred juice product.

Yet another approach to reducing cost has been the use of blends of high cost and low cost juice varieties. Expensive juices having consumer preferred taste characteristics are blended with less expensive, less taste preferred juice varieties. However, this solution is not without its own set of problems. Most notably, the inverse relationship that exists between the use of less preferred juice varieties and the consumer's positive taste perception of the finished beverage product. As the proportion of “cheaper” juices used increases, the consumer's positive flavor perception of the finished beverage product decreases.

Additionally, juice beverages made from blends of high cost and low cost juice materials frequently impose additional processing and production complexities. This, in turn, can also increase production and consumer purchase cost.

Considerable effort, therefore, has been expended in an attempt to address the consumer acceptance limitations of using low cost juice materials in the production of high quality beverage products. There remains a need in the art for compositions and methods for flavoring juice comprising beverages that ensures consistent, high product quality, that are easily adaptable to a variety of less costly juice materials, and are economical and easy to use. Accordingly, it is an object of the present invention to provide compositions and methods which address these needs and provide farther related advantages.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 Is a flow diagram describing the process steps of the present invention.

### DETAILED DESCRIPTION OF THE INVENTION

The present invention relates to novel beverage compositions with enhanced flavor characteristics. In particular, the present invention relates to novel processes for preparing beverage compositions and the products comprising them.

A. DEFINITIONS

As used herein, the term “beverage source” is defined as any edible plant material that can be used to make a beverage composition, including but limited to fruits, seeds, vegetables, berries, leaves, bark, grains, roots, etc.. The beverage source can optionally be fermented.

The beverage source can be in a variety of forms including, but not limited to, juices, cherries, beans, leaves, and bark. Additionally, the beverage source can take the form of a soluble beverage composition, or a beverage extract via aqueous, super-critical fluid, and organic solvent extraction processes;. The beverage source can also be caffeinated, decaffeinated, or a blend of both.

As used herein, the term “beverage source component” is defined as one of the taste contributing acids contained within the beverage source. One skilled in the art will appreciate that by the term acid it is meant the combination of the acid's associated and dissociated forms. The beverage source component is generated or formed as a result of beverage source growing, harvesting, processing, roasting, fermentation, preparation, handling and/or storage processes.

As used herein, the term “taste contributing” is defined as an acid contained within the beverage source whose concentration is directly or inversely correlated to processing conditions, whose concentration varies with beverage region of origin, whose concentration varies with beverage species, and is perceptible by taste at a concentration in water that is identical to the concentration of the acid in the target beverage. Perceptible by taste is defined as modifying the sensory perception of one or more of the following beverage flavor characteristics: sweet, sour, salty, bitter, soury, winey, acidy, mellow, bland, sharp, harsh, pungent, etc..

As used herein, the term “beverage source component profile” is defined as the concentration of beverage source components present within the beverage source. The beverage source component profile can be represented by a graph, a table, or some other suitable visual representation showing the existence and concentrations of beverage source components.

As used herein, the term “supplemental beverage source component” is defined as a taste contributing acid. The taste contributing acid of the supplemental beverage source component corresponds to the taste contributing acid of the beverage source component, though it may exist in the same or a different form of the acid. The supplemental beverage source component can exist in one or more forms selected from the following group: acidic form of the taste contributing acid, anionic form of the taste contributing acid, and metallic and ammonium salt of the taste contributing acid.

As used herein, the term “beverage source component modifier” is defined as a compound, or set of compounds, that adjusts the perceptible concentration of one or more beverage source components. Acceptable beverage source component modifiers include one or more of the following sodium, magnesium, potassium, hydrogen, calcium, and ammonium cations, in combination with hydroxide, carbonate, bicarbonate, gluconate, and sulfates.

The addition of a beverage source component modifier will modify the taste perceptible concentration of one or more beverage source components. The addition of a beverage source component modifier is also used to adjust the pH value of the beverage portion of the beverage or composition, to within an acceptable range of the pH value of the juice element of the target composition or beverage.

As used herein the term “resulting beverage component” is defined as the combination of a beverage source component and a corresponding supplemental beverage source component.

As used herein the term “resulting beverage component profile” is defined as the concentration of one or more resulting beverage components present within a beverage portion. The resulting beverage component profile can be represented by a graph, a table, or some other suitable visual representation showing the existence and concentrations of resulting beverage components.

As used herein, the term “target beverage” is defined as any edible plant material that can be used to make a beverage composition, including but limited to fruits, seeds, vegetables, berries, leaves, bark, grains, roots, etc.. The target beverage can optionally be fermented.

The target beverage can be in a variety of forms including, but not limited to, juices, cherries, beans, leaves, and bark. Additionally, the target beverage can take the form of a soluble beverage composition, or a beverage extract via aqueous, super-critical fluid, and organic solvent extraction processes;. The target beverage can also be caffeinated, decaffeinated, or a blend of both.

As used herein, the term “target beverage component” is defined as one of the taste contributing acids contained within the target beverage. One skilled in the art will appreciate that by the term acid it is meant the combination of the acid's associated and dissociated forms. The target beverage component is generated or formed as a result of beverage source growing, harvesting, processing, roasting, fermentation, preparation, handling and/or storage processes.

As used herein, the term “target coffee component profile” is defined as the concentration of target coffee components present within the beverage source. The target coffee component profile can be represented by a graph, a table, or some other suitable visual representation showing the existence and concentrations of target coffee components.

As used herein, the term “comprising” means various components and processing steps can be conjointly employed in the coffee products and process of the present invention. Accordingly, the term “comprising” encompasses the more restrictive terms “consisting essentially of” and “consisting of.”

B. Coffee Source

It has been determined according to the present invention that juice comprising beverages and compositions that exhibit consumer preferred flavor characteristics may be produced from a variety of beverage sources. The preferred beverage source for a particular use may vary according to considerations of availability, expense, and flavor associated with the beverage source. Additionally, the degree and nature of impurities and other components in the beverage source may be considered. A juice beverage or composition may also be produced from a blend of one or more suitable beverage sources.

The flavored beverages and compositions of the present invention comprise a juice portion, and may optionally contain additional components, such as foaming agents, mouthfeel enhancing agents, flavorants, creamy components, inert fillers and carriers, sweetening agents, and the like. The beverage portion is comprised of a beverage source, and any supplemental beverage source component and/or beverage source component modifier required.

Beverage sources exist in a variety of forms including, but not limited to juices, cherries, leaves, bark, and extracts including aqueous, super-critical fluid, and organic solvents, and mixtures thereof. Furthermore, the beverage source can be caffeinated, decaffeinated, or a blend of both. It is recognized that beverage sources suitable for use in the present invention may contain various impurities and/or by-products.

Beverage sources of the present invention are defined by beverage variety (i.e., juice species and region of origin). By region of origin it is meant a juice growing region wherein the juice growing process utilizes identical juice species. Additionally, a region of origin experiences similar soil conditions, fertilization conditions, growing environment (e.g., rainfall amount, temperature, altitude, sunlight), and pre-roasting process, handling, and storage conditions. The species, region of origin, and juice growing, harvesting, processing, roasting, fermentation, preparation, handling and/or storage process conditions determine the presence and concentration of a given acid in a beverage source.

It has been found that the beverage sources of the present invention contain one or more of the following acids: Formic, Acetic, Propanoic, Butanoic, Pentanoic, Hexanoic, Heptanoic, Octanoic, Nonanoic, Decanoic, Palmitic, Crotonic, Isocrotonic, Hydroxyacetic, Isobutyric, Lactic, 3-hydroxypropanoic, Glyceric, 2,3-dihydroxypropanoic, 2-(4-methoxyphenoxy) propanoic, 2-hydroxybutyric, 2,4-dihydroxybutyric, 2-methylbutanoic, Isovaleric, Methacrylic, Tiglic, Angelic, 3-methyl-2-butenoic, Pyruvic, 2-Oxobutyric, 3-oxobutanoic, Levulinic, Oxalic, Malonic, Succinic, Glutaric, Fumaric, Maleic, Methylsuccinic, Malic, Tartaric, 2-hydroxyglutaric, Ketoglutaric, Citraconic, Mesaconic, Itaconic, Citric, Aspartic, Glutamic, Pyroglutamic, Nicotinic, 2-Furoic, Benzoic, 3-hydroxybenzoic, 4-hydroxybenzoic, 2,5-dihydroxybenzoic, 3,4-dihydroxybenzoic, 3,4,5-Trihydroxybenzoic, 1,2,4-trihydroxybenzoic, Vanillic, Phytic, Phosphoric, Quinic, Caffeic, Ferulic, 3-(4-Hydroxy-3-methoxyphenyl)-2-propenoic, p-coumaric, o-coumaric, 4-methoxycinnamic, 3,4-dimethoxycinnamic, 3,4,5-trimethoxycinnamic, 3-caffeoylquinic, 4-caffeoylquinic, 5-caffeoylquinic, 3-feruloylquinic, 4-feruloylquinic, 5-feruloylquinic, 3,4-dicaffeoylqunic, 3,5-dicaffeoylqunic, 4,5-dicaffeoylqunic, p-coumaroylquinic, caffeoylferuoylqunic. The exact concentration within a given beverage source depends on the juice species selected, the growing and harvesting conditions, and the beverage source preparation processes described above.

C. Beverage Source Component

A beverage source component is defined as a taste contributing acid present within a given beverage source. As used herein the term “taste contributing” is defined as an acid contained within the beverage source that is perceptible by taste at a concentration in water that is identical to the concentration of the acid in the target beverage. Perceptible by taste is defined herein as modifying the sensory perception of one or more of the following flavor characteristics: sweet, sour, salty, bitter, soury, winey, acidy, mellow, bland, sharp, harsh, pungent, etc.. In addition, a taste contributing acid is an acid whose concentration exhibits the following phenomenon: a processing effect; a species effect; and a region of origin effect.

As used herein the term processing effect is defined as the existence of a relationship between the concentration of the acid in a processed beverage source and the processing conditions selected.

As used herein, the term species effect is defined as an acid having a concentration in a beverage source of one juice species, subjected to a given set of growing, harvesting, and processing conditions, that is different from the concentration in a different juice species, subjected to identical growing, harvesting, and processing conditions.

As used herein, the term region of origin effect is defined as an acid having a concentration that is dependent on the juice plant growing, harvesting, processing, roasting, fermentation, preparation, handling and/or storage processes.

The presence of a given beverage source component, and its corresponding concentration within a beverage source, is a function of many factors. The factors vary depending on the specific beverage source selected. Most notable among these, however, is the selection of a specific juice species. Additionally, growing conditions such as rainfall amounts, temperature, fertilization, harvesting, handling, and storage of the juice species contribute greatly to the presence and concentration of a given beverage source component. Moreover, subsequent processing and preparation of the juice species may significantly impact beverage source component concentrations.

The beverage source component can exist within a beverage source in a variety of forms. Typically the beverage source component is present in the acidic form of the taste contributing acid. As an acid, the beverage source component exists in both the associated and disassociated forms of the acid. However, it has been found that in the present invention suitable beverage source components may also exist as a salt of the taste contributing acid.

D. Beverage Source Component Profile

A beverage source component profile is defined as the concentration of beverage source components present within a given beverage source. The beverage source component profile represents the beverage source component concentration at a pH value of 14, in the completely dissociated form of the acid. The beverage source component profile can take the form of a graph, a table, or some other suitable visual representation showing the existence and concentrations of beverage source components.

E. Target Beverage

As used herein the term “target beverage” is defined as beverage or composition derived from as any edible plant material, including but limited to fruits, seeds, vegetables, berries, leaves, bark, grains, roots, and the like. The target beverage comprises a juice element. The target beverages of the present invention may optionally contain additional elements, such as foaming agents, mouthfeel enhancing agents, flavorants, creamy components, inert fillers and carriers, sweetening agents, and the like.

The juice element of the target coffee is derived from any plant, seed, fruit, or vegetable in which an edible juice can be extracted. The juice element of the target beverage can be in a variety of forms including concentrates, juice blends, or extracts of coffee via aqueous, super-critical fluid, and organic solvent extraction processes. The juice element can also be caffeinated, decaffeinated, or a blend of both.

It has been found that the juice element of the target beverage contains one or more of the following acids: Formic, Acetic, Propanoic, Butanoic, Pentanoic, Hexanoic, Heptanoic, Octanoic, Nonanoic, Decanoic, Palmitic, Crotonic, Isocrotonic, Hydroxyacetic, Isobutyric, Lactic, 3-hydroxypropanoic, Glyceric, 2,3-dihydroxypropanoic, 2-(4-methoxyphenoxy) propanoic, 2-hydroxybutyric, 2,4-dihydroxybutyric, 2-methylbutanoic, Isovaleric, Methacrylic, Tiglic, Angelic, 3-methyl-2-butenoic, Pyruvic, 2-Oxobutyric, 3-oxobutanoic, Levulinic, Oxalic, Malonic, Succinic, Glutaric, Fumarie, Maleic, Methylsuccinic, Malic, Tartaric, 2-hydroxyglutaric, Ketoglutaric, Citraconic, Mesaconic, Itaconic, Citric, Aspartic, Glutamic, Pyroglutamic, Nicotinic, 2-Furoic, Benzoic, 3-hydroxybenzoic, 4-hydroxybenzoic, 2,5-dihydroxybenzoic, 3,4-dihydroxybenzoic, 3,4,5-Trihydroxybenzoic, 1,2,4-trihydroxybenzoic, Vanillic, Phytic, Phosphoric, Quinic, Caffeic, Ferulic, 3-(4-Hydroxy-3-methoxyphenyl)-2-propenoic, p-coumaric, o-coumaric, 4-methoxycinnamic, 3,4-dimethoxycinnamic, 3,4,5-trimethoxycinnamic, 3-caffeoylquinic, 4-caffeoylquinic, 5-caffeoylquinic, 3-feruloylquinic, 4-feruloylquinic, 5-feruloylquinic, 3,4-dicaffeoylqunic, 3,5-dicaffeoylqunic, 4,5-dicaffeoylqunic, p-coumaroylquinic, caffeoylferuoylqunic. The exact concentration of an given acid within a the juice element of the target beverage depends on the juice species selected, the growing and harvesting conditions, and juice element preparation processes described above.

The target beverage component profile is defined as the concentration of target beverage components present within the juice element of the target coffee. The target beverage component profile can be represented by a graph, a table, or some other suitable visual representation showing the existence and concentrations of target beverage components.

F. Beverage Source Component Modifier

A beverage source component modifier is defined as a compound, or combination of compounds, that adjusts the perceptible concentration of one or more beverage source components. In solution, an acid can exist entirely in an associated form, entirely in a dissociated form, or as a combination of the two. The proportion of a given acid that exists in its associated and dissociated states is, in part, a function of the equilibrium constant for the given acid. It is the associated form of an acid that is responsible for taste.

The human sense of taste detects the associated form of an acid, the dissociated form of the acid is imperceptible. In addition to adjusting the perceptible concentration of a beverage source component, the beverage source component modifier adjusts the pH value of the beverage portion. Acceptable beverage source component modifiers include: sodium, magnesium, potassium, hydrogen, calcium, and ammonium cations, in combination with hydroxide, carbonate, bicarbonate, gluconate, and sulfates.

The beverage source component modifier compounds can exist in a variety of forms. The beverage source component modifier may exist in a solution of water, or some other suitable aqueous medium. Moreover, the beverage source component modifier can exist in non-aqueous solutions (e.g., oil and glycerin). Alternatively, the beverage source component modifier may exist as one or more dry ingredients.

The beverage source component modifier can be combined with the beverage source in a variety of ways, depending on the nature and form of the beverage source and the beverage source component modifier. The beverage source component modifier could exist in an aqueous solution that is sprayed onto, or mixed with, the beverage source. Alternatively, the beverage source component modifier could exist in a dry state, and be mixed with the beverage source in a beverage composition. When the beverage composition is transformed into a beverage, the beverage source component modifier would then act to adjust the perceptible concentration of the beverage source component in the method described.

The form of the beverage source component modifier is only limited by the need to exist in a state capable of adjusting the perceived concentration of the beverage source component, in the final, consumable form of the beverage.

Beverage source component modifiers that are a combination of two or more suitable compounds can be combined with the beverage source together or separately. Additionally, multi-compound component modifiers can exists in different states (e.g., in solution or a dry state) so long as they are capable of adjusting the perceived concentration of the beverage source component, in the final, consumable form of the beverage.

The beverage source component modifiers of the present invention also need not be applied directly to the beverage source to be effective. The beverages and compositions of the present invention may include additional ingredients, such as foaming agents, mouthfeel enhancing agents, flavorants, creamy components, inert fillers and carriers, sweetening agents, and the like. The beverage source component modifiers may be combined with any of these additional ingredients, in a suitable form, such that they are capable of adjusting the perceived concentration of the beverage source component, in the final, consumable form of the beverage.

G. Supplemental Coffee Source Component

A supplemental beverage source component is defined as a taste contributing acid.

The taste contributing acid of the supplemental beverage source component corresponds to the taste contributing acid of the beverage source component, though it may exist in the same or a different form of the acid. The supplemental beverage source component can exist as either the acidic form of the taste contributing acid (e.g., Citric Acid; Malic Acid; Formic Acid; Fumaric Acid; Phosphoric Acid; 2-Furoic Acid; Lactic Acid; Acetic Acid.), or as a salt of the taste contributing acid (e.g., Mono-, Di-, or Tri- Sodium Citrate; Mono-, Di-, or Tri- Potassium Citrate; Mono-, or Di- Sodium Malate; Mono- or Di- Potassium Malate; Sodium Formate; Potassium Formate; Mono- or Di- Sodium Fumarate; Mono- or Di- Potassium Fumarate; Mono- or Di- Sodium Phosphate; Mono- or Di- Potassium Phosphate; Sodium Furoate; Potassium Furoate; Sodium Lactate; Potassium Lactate).

Though the supplemental source component can be any of the taste contributing acids, preferred taste contributing acids are the acids of the following anions: Quinate, Lactate, Acetate, Formate, 2-Furoate, 3-Methyl Malate, Citramalate, Hydroxyglutarate, Glutarate, Malate, Citraconate, Maleate, Mesaconate, Oxalate, Fumarate, Phosphate and Citrate.

The supplemental beverage source components of the present invention can exist in a variety of forms. The supplemental beverage source component may exist in a solution of water, or some other suitable aqueous medium. Moreover, the supplemental beverage source component can exist in non-aqueous solutions (e.g., oil and glycerin). Alternatively, the supplemental beverage source component may exist as one or more dry ingredients.

The supplemental coffee source component can be combined with the beverage source in a variety of ways, depending on the nature and form of the beverage source and the supplemental beverage source component. The supplemental beverage source component could exist in an aqueous solution that is sprayed onto, or mixed with, the beverage source. Alternatively, the supplemental beverage source component could exist in a dry state, and be mixed with the beverage source in a beverage or composition. When the beverage composition is transformed into a final beverage, the supplemental beverage source component would then act to supplement the total concentration of the corresponding beverage source component in the method described.

A supplemental beverage source component existing in solution could also be applied (e.g., by spraying or mixing) to a beverage source (e.g., cherries, leaves, and the like). The same is true for a supplemental beverage source component existing as a dry ingredient. The supplemental beverage source component can exist in any suitable form, in an intermediate state of the final, consumable beverage. The exact form of the supplemental beverage source component is only limited by the need to exist in a state capable of supplementing the total concentration of the corresponding beverage source component, in the final, consumable form of the beverage.

Supplemental beverage source components that are a combination of two or more suitable compounds can be combined with the beverage source together or separately. Additionally, multi-compound supplemental beverage source components can exists in different states (e.g., in solution or a dry state) so long as they are capable of supplementing the total concentration of the corresponding beverage source component, in the final, consumable form of the beverage.

The supplemental beverage source components of the present invention also need not be combined with the beverage source directly to be effective. The juice containing beverages and compositions of the present invention may include additional ingredients, such as foaming agents, mouthfeel enhancing agents, flavorants, creamy components, inert fillers and carriers, sweetening agents, and the like. The supplemental beverage source components may be combined with any of these additional ingredients, in a suitable form, such that they are capable of supplementing the total concentration of the corresponding beverage source component, in the final, consumable form of the beverage.

H. Total Acid Concentration v. Perceptible Acid Concentration

It has been found that the acids of the present invention exhibit characteristic flavor notes. Though the taste perceptibility of an acid in solution is a function of its concentration, the taste perceptibility of an acid is not necessarily directly correlated to the acid's total concentration. The human sense of taste is only capable of tasting an acid in its associated form. Therefore, the portion of the total acid concentration in a dissociated state, does not contribute to the taste perception of the acid's characteristic flavor.

Acids exist in both the associated or dissociated forms in aqueous solutions. The molecular equilibrium is simply expressed as

HA⇄H⁺+A₋

Associated Form

Dissociated Forms

The anions can also be found in solutions containing salts of the acid. Mathematical relationships for this equilibrium are described in any standard collegiate general chemistry text.

The dissociation constant Kₐ expresses the relationship of the three components of the equilibrium, in terms of their concentrations (molar), i.e.

Kₐ=([H⁺][anions])/[HA]

Hydrogen ion concentration is conveniently expresses by the symbol pH. The Henderson-Hasselbach equation relates the pH of a solution to the acid's Kₐ value:

pH=log([anions]/[HA])−log Kₐ

The negative logarithm of the dissociation constant is known as the PKₐ value, in a similar manner to the pH value (which is the negative logarithm of the hydrogen ion):

pH−pKₐ=log([anions]/[HA])

Changes in pH of a solution can result in different concentrations of an acid's associated and dissociated forms. As the pH value of a solution changes so does the ability to perceive through taste an acids characteristic flavor note.

In the present invention a beverage source is selected, and beverage source components are identified. A beverage source component profile, generated at a pH value of 14, shows the total concentration of the beverage source components in a completely dissociated state. The same process is done for a target beverage.

The concentration of the beverage source component in the beverage source component profile is compared to the concentration of the target beverage component in the target beverage component profile. If the concentration of the beverage source component is in excess of the concentration of the target beverage component then no action is taken. If, however, the concentration of the beverage source component is less than the concentration of the target beverage component, the beverage source component concentration is supplemented with a supplemental beverage source component.

The supplemental beverage source component adds sufficient quantities of the taste contributing acid to the juice portion of the beverage or composition, such that the concentration of the resulting beverage component (sum of the beverage source component and the supplemental beverage source component) is equal to or greater than the concentration of the target beverage component. This ensures that if pH value of the beverage portion, of the beverage or composition, is within an acceptable range of the pH value of the juice element of the target beverage, the concentration of the associated forms of the acids in each will approximate each other (i.e., mimic each other). A range from about 2 units above to about two units below the pH value of the juice element of the target beverage is preferred. A range of from about 1 unit above to 1 unit below is more preferred. A range of from about 0.5 units above to 0.5 units below is more preferred. A range of from about 0.2 units above to 0.2 units below is more preferred. A range of from about 0.1 units above to 0.1 units below is most preferred. If the total concentration of the acid (associated and dissociated forms) in the beverage portion is at least equal to the total concentration of the acid in the juice element of the target beverage, then at pH values within the acceptable range, the two will have sufficiently similar concentrations of the associated form of the acid so as to deliver the same perceived flavor note and intensity of the acid.

The pH value of all substances is measured at standard temperature and pressure, herein after referred to as STP (25° C., 760 mmHg).

I. Preparation of Coffee Beverages and Compositions

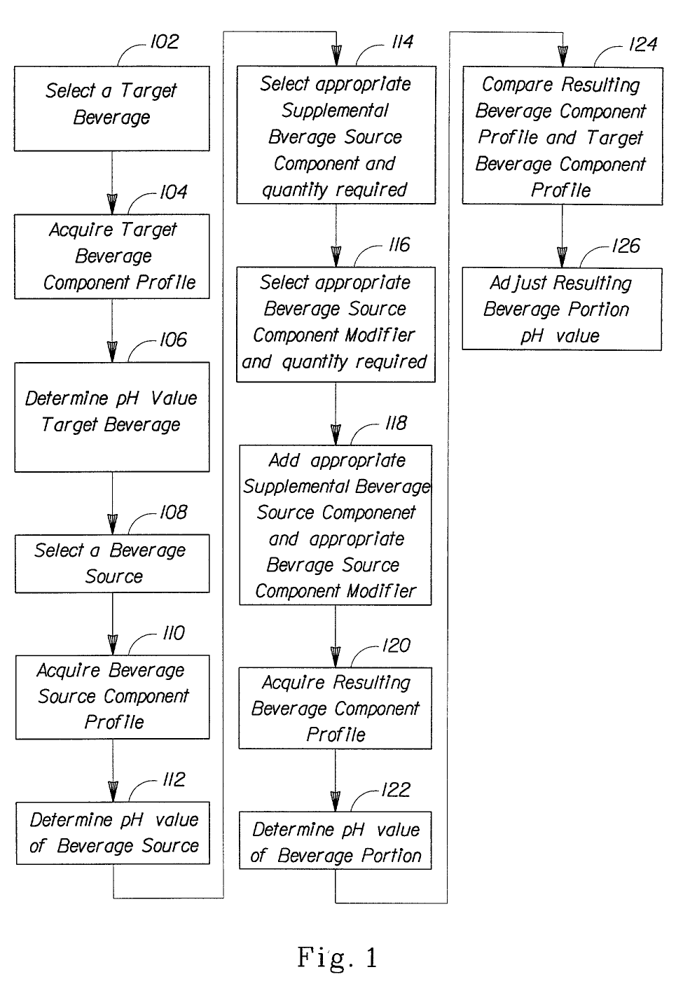

FIG. 1 is a flow diagram of the steps for the process of the present invention. Referring to the figure, step 102 is to select a target beverage comprising a juice element.

The target beverage may optionally contain additional elements, such as foaming agents, mouthfeel enhancing agents, flavorants, creamy components, inert fillers and carriers, sweetening agents, and the like.

Step 104 is to acquire the target beverage component profile showing the concentration of the target beverage components. Step 106 is to determine the pH value of the juice element of the target beverage. The pH value is measured at standard temperature and pressure. One skilled in the art will appreciate that though the juice element of the target beverage might have a given pH value, the pH value of the target beverage as a whole might be different, depending on the presence of additional elements.

Step 108 is to select a suitable beverage source. The beverage source can be derived from a variety of forms such as cherries, beans, leaves, and bark. Step 110 is to acquire the beverage source component profile showing the concentration of the beverage source components. Step 112 is to determine the pH value of the beverage source. The pH value is measured at standard temperature and pressure.

Step 114 is to select the appropriate supplemental beverage source component and the amount required to modify the beverage source component profile. The quantity of supplemental beverage source component required is determined by the difference between the total concentration of the beverage source component and the target beverage component. If the total concentration of the beverage source component is less than the total concentration of the target beverage component, a sufficient amount of a supplemental coffee source component is added so that the total concentration of the resulting beverage source component is at least equal to the total concentration of the target beverage component. However, if the total concentration of the beverage source component is in excess of the total concentration of the target beverage component, then the addition of a supplemental beverage source component is not required.

Step 116 is to select the appropriate beverage source component modifier, and the amount required, to adjust the perceptible concentration of the resulting beverage source component so that it is substantially similar to that of the target beverage component. This will allow the beverage portion profile to appropriately mimic the target beverage profile. The amount of beverage source component modifier required depends, in part, on the beverage source and the juice element of target beverage selected.

Step 118 is to formulate the beverage portion by combining the selected supplemental beverage source components and the beverage source component modifier with the beverage source. As described above, the supplemental beverage source component and beverage source component modifier can exist and be applied in a variety of forms. Moreover, the application of the supplemental beverage source components and beverage source component modifier does not have to occur simultaneously.

The components can be applied at any point in the preparation of the beverages or compositions of the present invention. Or, during the formation of any intermediate product used in the creation of the beverages or compositions of the present invention.

Depending on the beverage source selected, the supplemental beverage source components and the beverage source component modifier can be delivered to the beverages or compositions of the present invention: by a machine or other dispensing apparatus; by impregnating the ingredients in the lining of a cup; by impregnating the ingredients in a filter; by pre-measured tablet or packet; and/or, through the water used in various stages of product preparation (e.g., the roasting quench used to cool a post-roasted coffee, or the water used to create the final, consumable coffee beverage). The components and modifiers can be introduced via spraying, coating, soaking, co-mixing, or other suitable method. These methods may also be employed in tandem.

Step 120 is to acquire the resulting beverage component profile showing the total concentration of the resulting beverage source components. Step 122 is to determine the pH value of the beverage portion. The pH value is measured at standard temperature and pressure. Steps 124 and 126 require validating the results by comparing the resulting beverage component profile with the target beverage component profile, and ensuring that the beverage portion is within an acceptable pH range of the juice element of the target beverage.

One skilled in the art will appreciate that each and every step of the method described above is not required for every execution of the present invention. The exact sequence and number of steps required is dependent on the particular execution of the present invention.

### J. EXAMPLES

The following examples further describe and demonstrate embodiments within the scope of the present invention. These examples are given solely for the purpose of illustration and are not to be construed as a limitation of the present invention, as many variations thereof are possible without departing from the invention's spirit and scope.

1. Method for Determination of Coffee Components

The beverage components of the present invention are separated and quantified by Ion Chromatography (IC) utilizing alkaline anion-exchange with conductivity detection. The system is a Dionex DX 500 Ion Chromatograph comprising:

i) IP25 Isocratic Pump;

ii) EG-40 Eluent Generator;

iii) Ion Pac ATC-1 anion-trap PN#37151;

iv) AS50 Autosampler;

v) LC30 Chromatography Oven;

vi) Ion Pac AS-11 HC column (4 mm×20 cm) (PN 052960);

vii) Ion Pac AG-11-HC (PN 052962) guard column;

viii) CD20 Conductivity Detector; and,

ix) 4 mm ASRS-Ultra suppressor.

The chromatographic column consists of a 9-μm highly cross-linked macroporous ethylvinylbenzene-divinylbenzene resin core with 70-nm diameter microbeads of anion-exchange latex attached to the surface. The mobile phase is electrolytically generated from distilled-deionized water by using a Dionex EG-40 Eluent Generator and is characterized as follows:

1. Eluent A: 18 Mohm-cm Milli-Q water or better, filtered through a 0.45 mm filter, degassed, and transferred to reservoir A with a continuous blanket of nitrogen.

2. Eluent B: Potassium Hydroxide Cartridge (EluGen EGC-KOH EluGen cartridge, Dionex Inc.)

Deionized water is delivered by the pump to the EluGen Cartridge in the EG40. DC current is applied to the EluGen Cartridge to produce potassium hydroxide eluent. The resulting mobile phase gradient is described in Table 1 below.

TABLE 1

| time (min) | [NaOH] (mM) | Ramp |
|---|---|---|
| 0 | 1 | |
| 15 | 1 | isochratic |
| 25 | 15 | linear |
| 35 | 30 | linear |
| 60 | 60 | linear |

The column is kept at a temperature of 32° C. The flow rate is 1.5 mL/min and the injection volume is 10 μL. The data collection time is 55 minutes at a data collection rate of 5 points per second.

The above described analytical method is further disclosed in Dionex Corporation Application Note 123, “Determination of Inorganic Anions and Organic Acids in Fermentation Broths” and, Dionex Corporation Application Note 25, “Determination of Inorganic Anions and Organic Acids in Non-Alcoholic Carbonated Beverages”, herein incorporated by reference.

The first step in the method for the identification, separation, and quantification of coffee components is to prepare an aqueous sample solution of the substance to be analyzed (coffee source, target coffee, or coffee portion). The aqueous sample solution must then be filtered to remove large suspended solids. A purified sample is then collected and analyzed using the above equipment.

By way of example, if the substance to be analyzed is roasted and ground coffee then first weigh 2.0 grams of R&G into a 100 ml volumetric flask. Add 50 ml of boiling HPLC water to the sample and boil on a hot plate for 10 minutes. Cool to room temperature and bring to volume with HPLC water. Then filter 2 ml through a 0.45 mm Nylon Membrane filter (acrodisc). Discard the first 1 ml and collect the second 1 ml in a sample vial and cap. Finally, analyze the purified sample using the above described equipment.

If the substance to be analyzed is a brewed coffee then filter approximately 2 ml through a 0.45 mm Nylon Membrane filter (acrodisc). Discard the first 1 ml and collect the second 1 ml in a sample vial and cap. Finally, analyze the purified sample using the above described equipment.

If the substance to be analyzed is a soluble coffee then weigh 1 gram of the soluble coffee into a 100 ml volumetric flask. Add 50 ml of boiling HPLC water to the sample. Swirl the solution to mix well, then cool and dilute to volume. Then filter 2 ml through a 0.45 mm Nylon Membrane filter (acrodisc). Discard the first 1 ml and collect the second 1 ml in a sample vial and cap. Finally, analyze the purified sample using the above described equipment.

If the substance to be analyzed is a coffee extract then it will need to be diluted in order to pass through the 0.45 mm Nylon Membrane filter (acrodisc). The extent of the dilution is dependent upon the viscosity of the particular sample to be analyzed. If the sample to be analyzed is in a form other than described above it will need to be prepared as outlined above. Samples that will not be analyzed shortly following preparation require refrigeration.

Calibration of the Ion Chromatography Method

One skilled in the art will appreciate that calibration is necessary to convert detector response to measures of concentration (e.g., parts per million, milligrams per liter, and the like). Calibration of the IC method is performed by preparing solutions of the free acids (when available as solids of sufficient purity) or of the sodium or potassium salts. Response factors (RF, ppm/peak area) were determined by a five level calibration for quinic, lactic, acetic, formic, malic, phosphoric and citric acids. Where the salts were used, gravimetric factors were applied such that the RF values corresponded to free acid concentration (ppm).

Quinic Acid

Quinic acid (Aldrich 77-95-2, 98% pure, FW=192.17 g/mol) was used. A primary stock solution was prepared by weighing 0.1015 g into a 100 mL volumetric flask. A secondary stock was prepared by 10-fold dilution. Five calibration solutions were made by successive 2-fold dilutions of the secondary stock. The fit was linear (r²=0.9998) over a 6 to 100 ppm range.

Lactic Acid

Sodium lactate (Sigma L-7022, approx. 98% pure, FW=112.06 g/mol) was dried overnight in a desiccator containing CaSO₄. A primary stock solution was prepared by weighing 0.1079 g into a 100 mL volumetric flask. A secondary stock was prepared by 10-fold dilution. Five calibration solutions were made by successive 2-fold dilutions of the secondary stock. The fit was linear (r²=0.9996) over a 5 to 85 ppm range.

Acetic Acid

Sodium acetate (Sigma S7545, 99.0% pure, FW=82.03 g/mol) was used. A primary stock solution was prepared by weighing 0.1035 g into a 100 mL volumetric flask. A secondary stock was prepared by 10-fold dilution. Five calibration solutions were made by successive 2-fold dilutions of the secondary stock. A quadratic fit (r²=0.9999) was preferred to a linear fit (r²=0.984) over the 5 to 75 ppm range.

Formic Acid

Sodium formate (Sigma S2140, 99.6% pure, FW=68.01 g/mol) was used. A primary stock solution was prepared by weighing 0.1007 g into a 100 mL volumetric flask. A secondary stock was prepared by 10-fold dilution. Five calibration solutions were made by successive 2-fold dilutions of the secondary stock. The fit was linear (r²=0.9990) over a 4 to 70 ppm range.

Malic Acid

Malic acid (Aldrich 617-48-1, 99+ % pure, FW=134.09 g/mol) was used. A primary stock solution was prepared by weighing 0.1020 g into a 100 mL volumetric flask. A secondary stock was prepared by 10-fold dilution. Five calibration solutions were made by successive 2-fold dilutions of the secondary stock. A quadratic fit (r²=0.9999) was preferred to a linear fit (r²=0.985) over the 6 to 100 ppm range.

Phosphoric Acid

Potassium phosphate, monobasic (Aldrich 7778-77-0, 99% pure, FW=136.09 g/mol) was used. A primary stock solution was prepared by weighing 0.1020 g into a 100 mL volumetric flask. A secondary stock was prepared by 10-fold dilution. Five calibration solutions were made by successive 2-fold dilutions of the secondary stock. Fit was linear (r²=0.9999) over a 5 to 75 ppm range.

Citric Acid

Citric acid (Aldrich 77-92-9, 99+% pure, FW=192.12 g/mol) was used. A primary stock solution was prepared by weighing 0.1034 g into a 100 mL volumetric flask. A secondary stock was prepared by 10-fold dilution. Five calibration solutions were made by successive 2-fold dilutions of the secondary stock. A quadratic fit (r²=0.9999) was preferred to a linear fit (r²=0.989) over the 6 to 100 ppm range.

### 2. EXAMPLES

### Example 1

In one embodiment of the present invention a target beverage comprising a juice element is identified (100% dilute passion fruit juice). The target beverage is prepared from a passion fruit juice concentrate. This produces a 15% aqueous solution of the target beverage.

A filtered 2 ml aliquot of the aqueous solution of the target beverage is then analyzed for total ion concentration of target beverage components. This is done using a Dionex 500 HPLC system and the analytical method for determining ion concentration described above. A target beverage component profile is identified in PPM.

A beverage source is identified and processed (100% dilute apple juice). The beverage source is prepared from an apple juice concentrate. This produces a 15% aqueous solution of the beverage source.

A filtered 2 ml aliquot of the aqueous solution of the beverage source is then analyzed for total ion concentration of beverage source components using a Dionex 500 HPLC system and the analytical method for determining ion concentration described above. A beverage source component profile is identified in PPM.

The quantity of the supplemental beverage source component to be added is calculated as the difference between the total ion concentration of the target beverage component and the beverage source component.

A quantity of a supplemental beverage source component, in an amount that is equal to or greater than the amount of the difference between the target beverage component and the beverage source component, is combined with the beverage source. The supplemental beverage source component is added in its acidic form. However, the supplemental beverage source component may also be added as the Na⁺ or K⁺ salt of the acid.

The pH value of the juice element of the target beverage is measured at standard temperature and pressure. The pH value of the beverage portion is then measured and adjusted with a sufficient amount of a beverage source component modifier (NaOH) to be within +/−0.1 units of the pH of the juice element of the target beverage.

A filtered 2 ml aliquot of the beverage portion is then analyzed for total ion concentration using the analytical method for determining ion concentrations described above. A resulting beverage component profile is then identified in PPM and compared with target beverage component profile.

Having now described several embodiments of the present invention it should be clear to those skilled in the art that the forgoing is illustrative only and not limiting, having been presented only by way of exemplification. Numerous other embodiments and modifications are contemplated as falling within the scope of the present invention as defined by the appended claims thereto.

What is claimed is:

1. A ready to drink beverage composition comprising:
a beverage portion comprising a resulting beverage component, said beverage portion exhibiting a resulting beverage component profile, said beverage portion comprising:
i) a beverage source comprising a beverage source component, said beverage source exhibiting a beverage source component profile;
ii) a beverage source component modifier;
iii) a supplemental beverage source component;
wherein the amount of said resulting beverage component mimics the amount of a target beverage component in a component profile of a target beverage,
and wherein said beverage portion has a pH value in the range of from about 2.0 units below to about 2.0 units above the pH value of a juice element of said target beverage.

2. A dry beverage composition comprising:
a beverage portion comprising a resulting beverage component, said beverage portion exhibiting a resulting beverage component profile, said beverage portion comprising:
i) a beverage source comprising a beverage source component, said beverage source exhibiting a beverage source component profile;
ii) a beverage source component modifier;
iii) a supplemental beverage source component;
wherein the amount of said resulting beverage component mimics the amount of a target beverage component in a component profile of a target beverage,
and wherein said beverage portion provides a pH value in use in the range of from about 2.0 units below to about 2.0 units above the pH value of a juice element of said target beverage.
